(19) United States
(12) Patent Application Publication
(10) Pub. No.: US 2010/0239947 A1
(43) Pub. Date: Sep. 23, 2010

(54) Condensed ring-containing polymer electrolyte and application thereof

(75) Inventors: Takashi Yamada, Tsukuba-shi (JP); Shigeru Sasaki, Tsukuba-shi (JP)

Correspondence Address: FOLEY AND LARDNER LLP;SUITE 500, 3000 K STREET NW, WASHINGTON, DC, 20007, US

(73) Assignee: Sumitomo Chemical Company, Limited

(21) Appl. No.: 12/308,564

(22) PCT Filed: Jun. 19, 2007
(86) PCT No.: PCT/JP2007/062653

§ 371 Date: Dec. 18, 2008

(30) Foreign Application Priority Data
Jun. 20, 2006 (JP) 2006-169710

(51) Int. Cl. H01M 8/10; C08J 5/20; B01J 31/08

(52) U.S. Cl. 429/483; 521/27; 502/159

(57) ABSTRACT

The polymer electrolyte of the present invention comprises a structural unit represented by the following general formula (1) in weight fraction of 1 to 30% by weight:

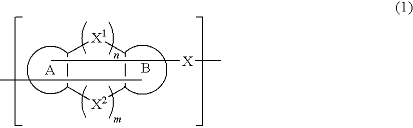

(in the formula, A-ring and B-ring each independently represent an optionally-substituted aromatic hydrocarbon ring or an optionally-substituted heterocyclic ring; X¹ and X² each independently represent —CO—, —SO— or —SO₂—; n and m each independently represent 0, 1 or 2, and n+m is not less than 1; when n is 2, two X¹s may be the same as or different from each other; when m is 2, two X²s may be the same as or different from each other; and X represents a direct bond or a divalent group). The polymer electrolyte has excellent water resistance while having high ion-conductivity.

### TECHNICAL FIELD

The present invention relates to a condensed ring-containing polymer electrolyte suitable for applications requiring water resistance, and particularly to a polymer electrolyte suitable for a component of solid polymer fuel cells.

### BACKGROUND ART

Polymer electrolytes having an ion-exchange group in a polymer chain are used in a variety of applications such as ion-exchange membranes, ion-conductive materials, sensors, microcapsules and water absorbent materials. These polymer electrolytes are known to absorb water and swell or to dissolve in an aqueous solvent, through hydration of an ion-exchange group therein. In some cases, for example, use of polymer electrolyte in the form of membrane, prevention of membrane degradation caused by swelling or partial dissolution of membrane (water resistance) is emphasized. Particularly for an ion-conductive membrane used in solid polymer fuel cells, which are actively developed in recent years, a polymer electrolyte having higher water resistance is required, because the ion-conductive membrane is exposed to a high temperature/high humidity environment.

Considering these situations, in order to improve water resistance of the ion-conductive membrane, various materials are developed. One of the methods for improving water resistance is a method of crosslinking a polymer electrolyte intermolecularly or intramolecularly. For example, Japanese Unexamined Patent Application Publication No. 2000-501223 describes a method of crosslinking a polymer electrolyte by treating it at high temperature to bind a part of a sulfonate group which is an ion-exchange group of the polymer electrolyte for fuel cell to each other. However, in the method, the treatment at high temperature requires complicated operations. In addition, detachment of the sulfonate group tends to simultaneously occur with the crosslinking reaction, resulting in a reduced ion-conductivity. Other polymer electrolytes are also developed, which are produced by introducing an ion-exchange group to polymer compounds having relatively high heat resistance and/or mechanical strength. Proposed are polymer electrolytes obtained by sulfonating a polyetherketone (e.g., Japanese Unexamined Patent Application Publication No. H11-502249) and by sulfonating a polyketone (e.g., see JP-A-2001-342241).

### DISCLOSURE OF THE INVENTION

However, the polymer electrolyte obtained by introducing an ion-exchange group to a polymer compound having excellent heat resistance and/or mechanical strength, tends to be unable to keep the form of membrane at high temperature because of dissolution of the polymer electrolyte itself, when the amount of ion-exchange group is introduced. As described above, in previous polymer electrolytes disclosed, an amount of ion-exchange group sulfonate group) introduced and water resistance are conflicting each other. Therefore, there is a strong need of a polymer electrolyte having such water resistance capable of keeping the form of membrane while containing an increased amount of ion-exchange group introduced.

The object of the present invention is to provide a new polymer electrolyte, which has high water resistance, contains an increased amount of ion-exchange group introduced (has high ion-conductivity) and is suitable for an ion-conductive membrane of a solid polymer fuel cell, and a solid polymer fuel cell using the polymer electrolyte.

To achieve the object, the present inventors have studied intensively about structural unit of polymer electrolyte, and have found that introduction of a particular structural unit to a polymer electrolyte results in a polymer electrolyte having a dramatically increased water resistance, and accomplished the present invention.

That is, the present invention provides a polymer electrolyte of [1].

[1] A polymer electrolyte comprising a structural unit represented by the following general formula (1) in weight fraction of 1 to 30% by weight:

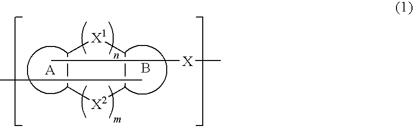

(in the formula, A-ring and B-ring each independently represent an optionally-substituted aromatic hydrocarbon ring or an optionally-substituted heterocyclic ring; X¹ and X² each independently represent —CO—, —SO— or —SO₂—; n and m each independently represent 0, 1 or 2, and n+m is not less than 1; when n is 2, two X¹s may be the same as or different from each other; when m is 2, two X²s may be the same as or different from each other; and X represents a direct bond or a divalent group).

The polymer electrolyte of the present invention comprising the structural unit represented by the general formula (1) is preferably a polymer electrolyte of the following [2] or [3], from the viewpoint of more improved water resistance.

[2] The polymer electrolyte according to [1], wherein A-ring and B-ring each independently represent an aromatic hydrocarbon ring without the ion-exchange group as a substituent or a heterocyclic ring without the ion-exchange group as a substituent, further comprising a structural unit having an ion-exchange group as an additional structural unit.

[3] The polymer electrolyte according to [1] or [2] represented by the following general formula (5):

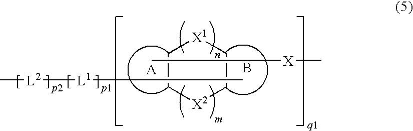

(in the general formula, A-ring, B-ring, X¹, X², X, n and m are the same as those being defined in the general formula (1); p1, p2 and q1 represent weight fraction of respective structural units, and p1+p2+q1=100% by weight; L¹ represents a structural unit having an ion-exchange group; and L² represents a structural unit without the ion-exchange group).

The present invention further provides polymer electrolytes of the following [4] to [7], which are preferred embodiments among polymer electrolytes comprising the structural unit represented by the general formula (1).

[4] The polymer electrolyte according to any one of [1] to [3], wherein X¹ represents —CO—, n=1, and m=0 in the general formula (1).

[5] The polymer electrolyte according to any one of [1] to [3], wherein X¹ and X² represent —CO—, n=1, and m=1 in the general formula (1).

[6] The polymer electrolyte according to any one of [1] to [3], wherein the structural unit represented by the general formula (1) is a structural unit represented by the general formula (2) and/or a structural unit represented by the general formula (3):

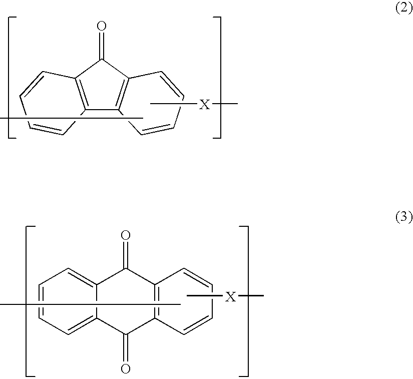

(in the formula, X is the same as that being defined in the general formula (1)).

[7] The polymer electrolyte according to any one of [1] to [3], wherein the structural unit represented by the general formula (1) is a structural unit represented by the general formula (2a) and/or a structural unit represented by the general formula (3a):

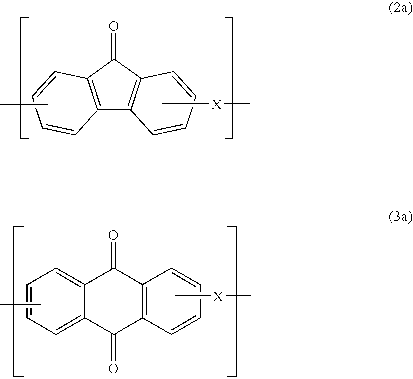

(in the formula, X is the same as that being defined in the general formula (1)).

The polymer electrolyte of the present invention is preferably used as a component of a solid polymer fuel cell, and provides the following [8] to [13].

[8] A polymer electrolyte membrane comprising any one of the polymer electrolytes.

[9] A polymer electrolyte composite membrane comprising any one of the polymer electrolytes and a porous substrate.

[10] A membrane-electrode assembly comprising the polymer electrolyte membrane according to [8] or the polymer electrolyte composite membrane according to [9], and a catalyst layer.

[11] A catalyst composition comprising any one of the polymer electrolytes and a catalyst ingredient.

[12] A membrane-electrode assembly including a catalyst layer comprising the catalyst composition according to [11].

[13] A solid polymer fuel cell including at least one of the polymer electrolyte membrane according to [8], the polymer electrolyte composite membrane according to [9] and a catalyst layer comprising the catalyst composition according to [12].

[14] A solid polymer fuel cell including the membrane-electrode assembly according to [10] or [12].

According to the present invention, the polymer electrolyte having excellent water resistance while having high ion-conductivity can be obtained. The polymer electrolyte exhibits high power generation characteristics when used in components for solid polymer fuel cell, particularly as an ion-conductive membrane, and is quite useful in industry.

### BEST MODE FOR CARRYING OUT THE INVENTION

The present invention will be described in detail below.

### [Polymer Electrolyte]

The polymer electrolyte of the present invention is a polymer having an ion-exchange group, characterized in having the structural unit represented by the general formula (1).

In the general formula (1), X¹ and X² each independently represent —CO—, —SO— or —SO²—. Among them, —CO— is preferred. n and m each independently represent 0, 1 or 2, and n+m is not lees than 1.

In the general formula (1), A-ring and B-ring each independently represent an optionally-substituted aromatic hydrocarbon ring or an optionally-substituted heterocyclic ring. The total number of carbon thereof is generally 4 to 18. Examples of the optionally-substituted aromatic hydrocarbon ring include a benzene ring, a naphthalene ring and those having a substituent on these rings. Examples of the optionally-substituted heterocyclic ring include a pyridine ring, a pyrimidine ring, a quinoline ring, an isoquinoline ring, a quinoxaline ring, a thiophene ring and those having a substituent on these rings. Examples of the substituent include ion-exchange groups, a fluorine atom, optionally-substituted alkyl groups having 1 to 10 carbon atoms, optionally-substituted alkoxy groups having 1 to 10 carbon atoms, optionally-substituted aryl groups having 6 to 18 carbon atoms, optionally-substituted aryloxy groups having 6 to 18 carbon atoms, and optionally-substituted acyl groups having 2 to 20 carbon atoms.

In the general formula (1), X represents a direct bond or a divalent group, and preferably a direct bond, an oxygen atom forming an ether bonding, or a sulfur atom forming a thioether bonding.

Examples of the optionally-substituted alkyl group having 1 to 10 carbon atoms include alkyl groups having 1 to 10 carbon atoms such as a methyl group, an ethyl group, an n-propyl group, an isopropyl group, an n-butyl group, a sec-butyl group, an isobutyl group, an n-pentyl group, a 2,2-dimethylpropyl group, a cyclopentyl group, an n-hexyl group, a cyclohexyl group, a 2-methylpentyl group, a 2-ethylhexyl group and a nonyl group and these alkyl groups having a substituent such as an ion-exchange group, a fluorine atom, a hydroxyl group, a nitrile group, a methoxy group, an ethoxy group, an isopropyloxy group, a phenyl group, a naphthyl group, a phenoxy group and a naphthyloxy group.

Examples of the optionally-substituted alkoxy group having 1 to 10 carbon atoms include alkoxy groups having 1 to 10 carbon atoms such as a methoxy group, an ethoxy group, an n-propyloxy group, an isopropyloxy group, an n-butyloxy group, a sec-butyloxy group, a tert-butyloxy group, an isobutyloxy group, an n-pentyloxy group, a 2,2-dimethylpropyloxy group, a cyclopentyloxy group, an n-hexyloxy group, a cyclohexyloxy group, a 2-methylpentyloxy group and a 2-ethylhexyloxy group and these alkoxy groups having a substituent such as an ion-exchange group, a fluorine atom, a hydroxyl group, a nitrile group, a methoxy group, an ethoxy group, an isopropyloxy group, a phenyl group, a naphthyl group, a phenoxy group and a naphthyloxy group.

Examples of the optionally-substituted aryl group having 6 to 18 carbon atoms include aryl groups such as a phenyl group and a naphthyl group and these aryl groups having a substituent such as an ion-exchange group, a fluorine atom, a hydroxyl group, a nitrile group, a methoxy group, an ethoxy group, an isopropyloxy group, a phenyl group, a naphthyl group, a phenoxy group and a naphthyloxy group.

Examples of the optionally-substituted aryloxy group having 6 to 18 carbon atoms include aryloxy groups such as a phenoxy group and a naphthyloxy group and these aryloxy groups having a substituent such as an ion-exchange group, a fluorine atom, a hydroxyl group, a nitrile group, a methoxy group, an ethoxy group, an isopropyloxy group, a phenyl group, a naphthyl group, a phenoxy group and a naphthyloxy group.

Examples of the optionally-substituted acyl group having 2 to 20 carbon atoms include acyl groups having 2 to 20 carbon atoms such as an acetyl, a propionyl, a butyryl, an isobutyryl, a benzoyl, a 1-naphthoyl and a 2-naphthoyl groups and these acyl groups having a substituent such as an ion-exchange group, a fluorine atom, a hydroxyl group, a nitrile group, a methoxy group, an ethoxy group, an isopropyloxy group, a phenyl group, a naphthyl group, a phenoxy group and a naphthyloxy group.

Introduction of the structural unit represented by the general formula (1) into a main chain of a polymer electrolyte can dramatically increase water resistance of the polymer electrolyte.

In the polymer electrolyte, a content of the structural unit represented by the general formula (1) is 1 to 30% by weight, preferably 2 to 25% by weight, more preferably 3 to 15% by weight, and even more preferably 3 to 10% by weight, represented by weight fraction to the total weight of the polymer electrolyte. The polymer electrolyte comprising the structural unit represented by the general formula (1) within the range of the weight fraction as above can achieve excellent water resistance and be easily processed into a component applied to the solid polymer fuel cell described below.

The A-ring and B-ring in the structural unit represented by the general formula (1) may have the substituent shown above, but the structural unit preferably has no ion-exchange group. In other words, the polymer electrolyte preferably comprises the structural unit in which A-ring and B-ring each independently represent an aromatic hydrocarbon ring without an ion-exchange group as a substituent or a heterocyclic ring without an ion-exchange group as a substituent (hereinafter referred to as a “structural unit without ion-exchange group represented by the general formula (1)”) and a structural unit having an ion-exchange group as an additional structural unit.

Specific examples of the polymer electrolyte comprising the structural unit without ion-exchange group represented by the general formula (1) and the structural unit having an ion-exchange group include a polymer electrolyte represented by the following general formula (4).

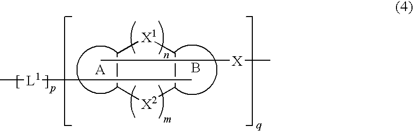

(in the formula, A-ring, B-ring, X¹, X², X, n and m are the same as those being defined in the general formula (1); L¹ represents a structural unit having an ion-exchange group; p and q represent weight fraction of respective structural units in the polymer electrolyte, and p+q=100% by weight).

A copolymerization mode in the general formula (4) may be random copolymerization, block copolymerization or a combination thereof. Examples of the copolymerization mode of the polymer electrolyte include:

i) a copolymerization mode, in which a polymer chain comprising the structural unit represented by L¹ has the structural unit represented by the general formula (1) partially introduced into the polymer chain;

ii) a copolymerization mode containing blocks obtained by linking structural units represented by L¹ and blocks obtained by linking structural units represented by the general formula (1);

iii) a copolymerization mode in which the structural units represented by L¹ and the structural units represented by the general formula (1) are alternately linked; and

iv) a copolymerization mode having a combination of copolymerization modes selected from i), ii) and iii) in a main chain.

L¹ can be any structural unit as long as it has an ion-exchange group, but is preferably a structural unit having an aromatic ring, and more preferably a divalent aromatic group, from the viewpoint of enhancing heat resistance of the polymer electrolyte. As used herein, the aromatic group includes groups obtained by eliminating two hydrogen atoms from aromatic and heterocyclic compounds and groups obtained by linking two or more groups obtained by eliminating two hydrogen atoms from aromatic and heterocyclic compounds, directly or through a divalent group.

In the general formula (4), weight fraction of structural units are 70 to 99% by weight for p, and 1 to 30% by weight for q as described above, and preferably 75 to 98% by weight for p, and 2 to 25% by weight for q.

Specific examples of the structural unit without ion-exchange group represented by the general formula (1) include the followings, wherein X is the same as that being defined in the general formula (1):

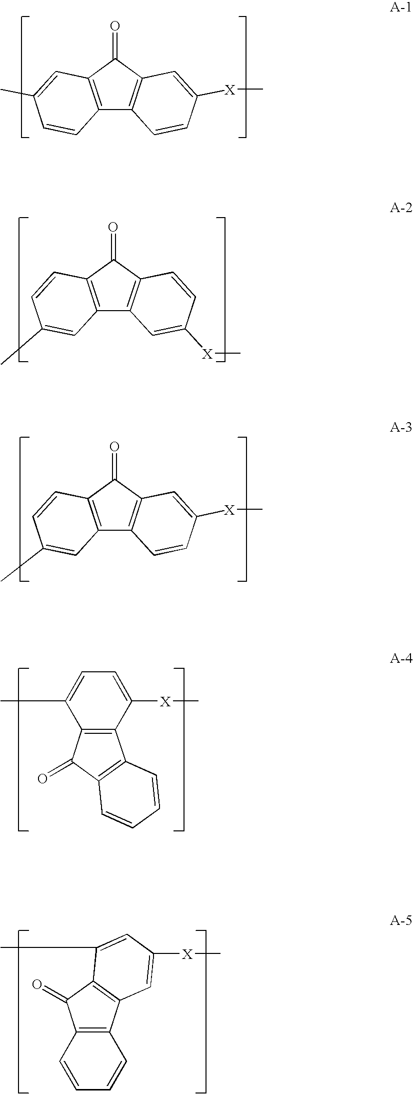

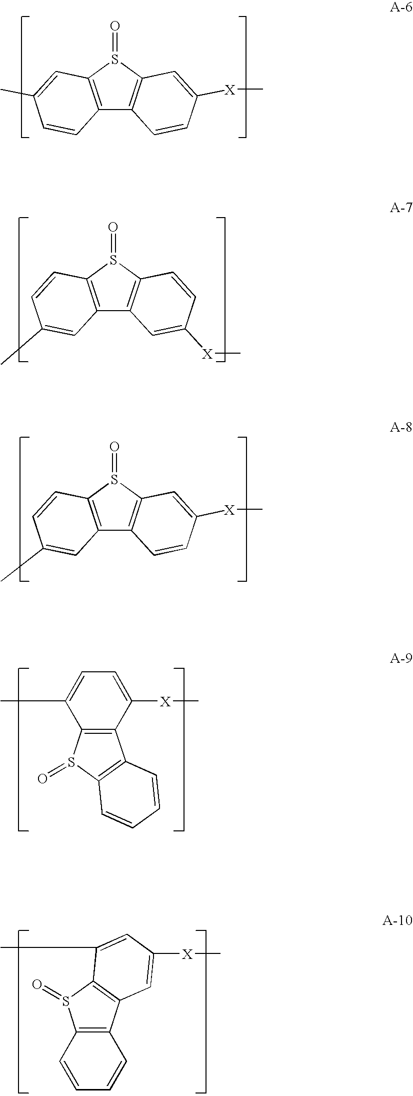

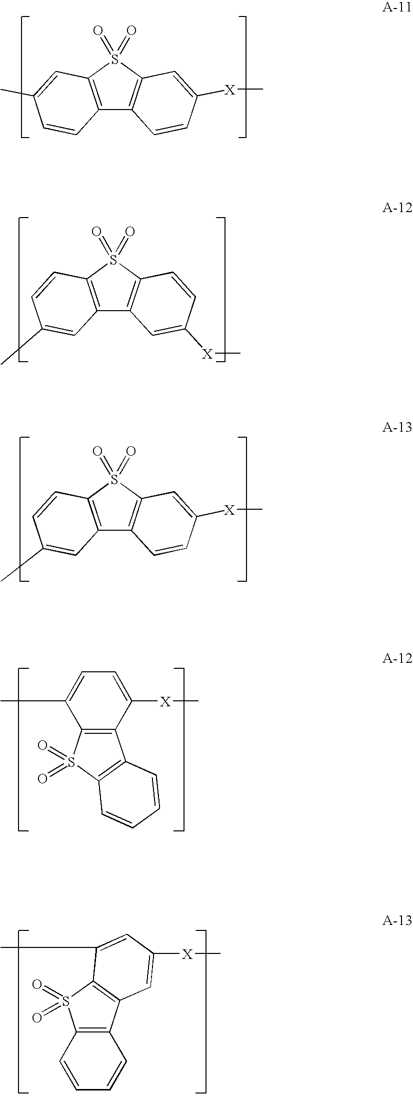

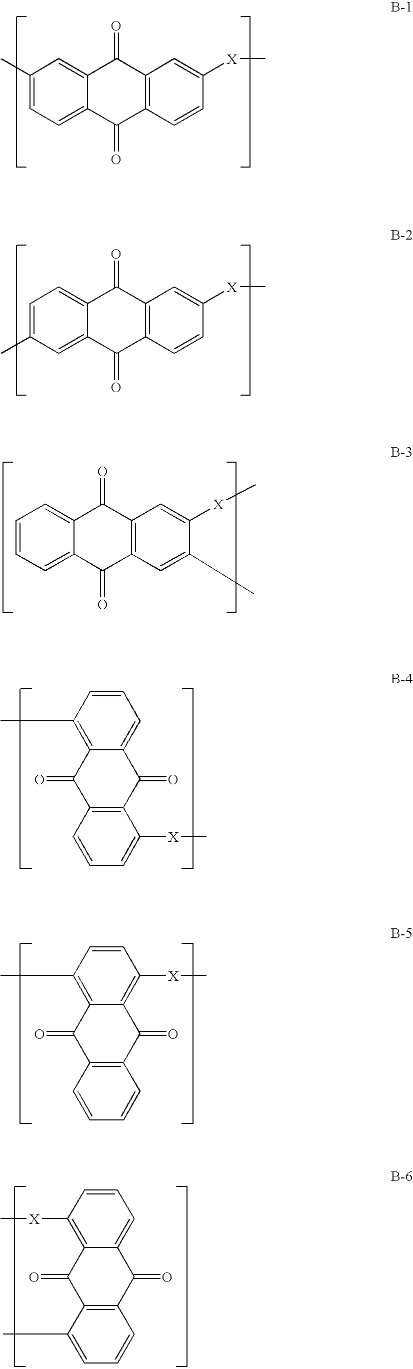

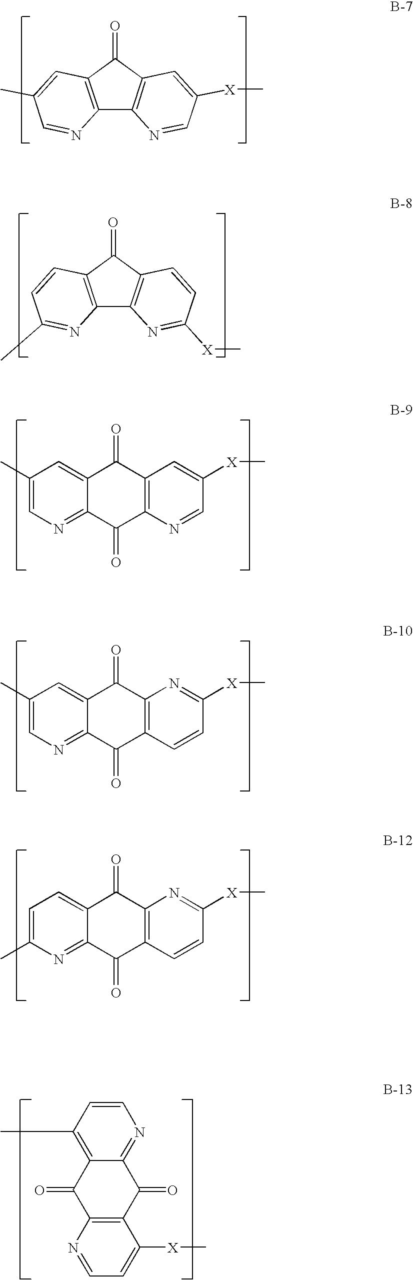

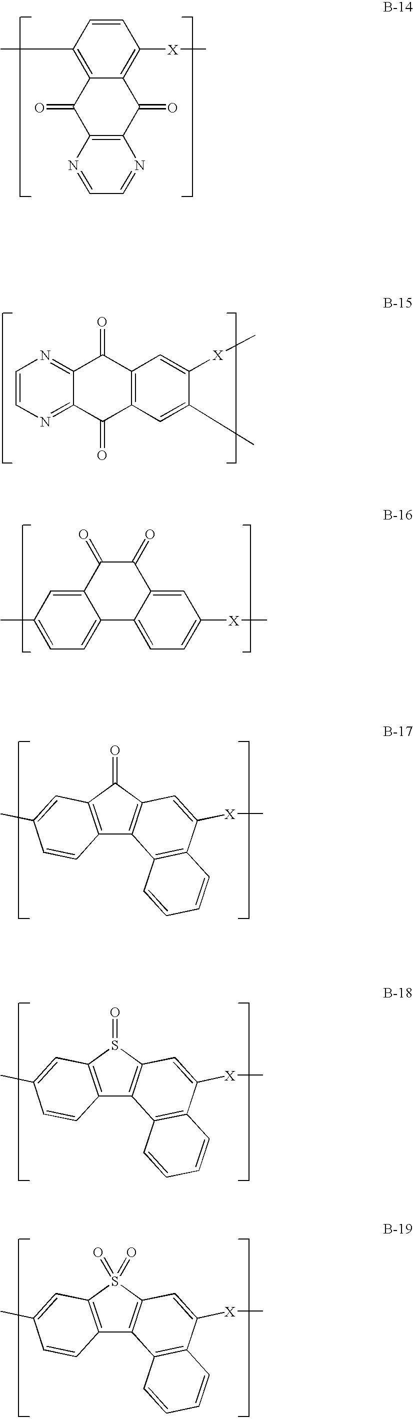

Among structural units shown above, preferred are structural units represented by the following general formula (2) and the following general formula (3):

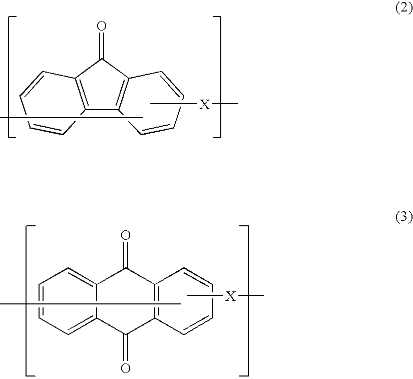

(in the formula, X is the same as that being defined in the general formula (1)).

Preferred examples of the structural unit represented by the general formula (2) include structural units represented by the following general formula (2a). Specific examples thereof include (A-1), (A-2) and (A-3) shown above.

Preferred examples of the structural unit represented by the general formula (3) include structural units represented by the following general formula (3a). Specific examples thereof include (B-1), (B-2), (B-4) and (B-6) shown above.

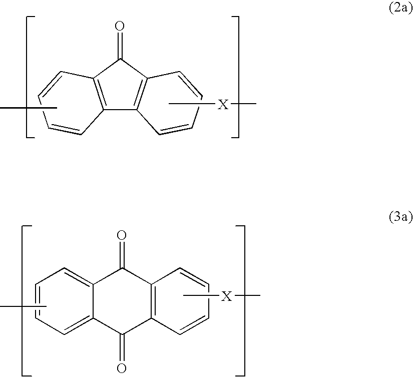

(in the formula, X is the same as that being defined in the general formula (1)).

The polymer electrolyte of the present invention has an ion-exchange group within a molecule. The ion-exchange group may be an acid or a basic group. When the polymer electrolyte is used in a solid polymer fuel cell, the ion-exchange group is preferably an acid group. Examples of the acid group include weak acid groups such as a carboxyl group (—COOH), a phosphate group (—OPO(OH)₂) and a phosphonate group (—PO(OH)₂), strong acid groups such as a sulfonate group (—SO₃H), a sulfinate group (—SO₂H), a sulfonimide group (—SO₂NHSO₂—) and a sulfate group (—OSO₃H) and super strong acid groups obtained by introducing an electron-withdrawing group such as a fluoro group at near position to the strong acid group, for example, at an alpha- or a beta-position. Among them, the strong and the super strong acid groups are preferred.

These acid groups may be partially or fully substituted with a metal ion to form a salt, but preferably be in the state of free acid for substantially all acid groups in the polymer electrolyte when used as an ion-conductive membrane for solid polymer fuel cell.

The polymer electrolyte of the present invention can further comprise a structural unit without the ion-exchange group in addition to the structural unit having the ion-exchange group and the structural unit represented by the general formula (1). Examples thereof include a polymer electrolyte represented by the following general formula (5).

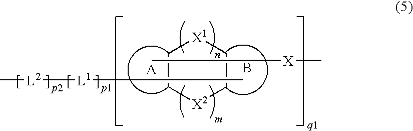

(in the formula, A-ring, B-ring, X¹, X², X, n and m are the same as those being defined in the general formula (1); p1, p2 and q1 represent weight fraction of respective structural units, and p1+p2++q1=100% by weight; L¹ is the same as that being defined in the general formula (4); and L² represents a structural unit without an ion-exchange group).

A copolymerization mode in the general formula (5) may be random copolymerization, block copolymerization or a combination thereof. Examples of the copolymerization mode of the polymer electrolyte include:

v) a copolymerization mode in which the structural unit represented by L¹, the structural unit represented by L² and the structural unit represented by the general formula (1) are randomly linked;

vi) a copolymerization mode in which a polymer chain obtained by alternatively linking the structural units represented by L¹ and the structural units represented by L², the structural unit represented by the general formula (1) being partially introduced into the polymer chain;

vii) a copolymerization mode in which blocks obtained by linking the structural units represented by L¹, blocks obtained by linking the structural units represented by L² and blocks obtained by linking the structural units represented by the general formula (1);

viii) a copolymerization mode in which blocks obtained by linking the structural units represented by L¹ and the structural units represented by the general formula (1) and blocks obtained by linking the structural units represented by L² and the structural units represented by the general formula (1);

ix) a copolymerization mode in which blocks obtained by linking the structural units represented by L¹ and blocks obtained by linking the structural units represented by L² and the structural units represented by the general formula (1);

x) a copolymerization mode in which blocks obtained by linking the structural units represented by L¹ and the structural units represented by the general formula (1) and blocks obtained by linking the structural units represented by L²;

xi) a copolymerization mode in which blocks obtained by linking the structural units represented by L¹ and the structural units represented by L² and blocks obtained by linking the structural units represented by the general formula (1);

xii) a copolymerization mode having a combination of copolymerization modes selected from v), vi), vii), viii), ix), x) and xi) in a polymer chain.

L² represents any structural unit, but preferably a divalent aromatic group similarly as L¹, from the viewpoint of enhancing heat resistance of the polymer electrolyte.

In the general formula (5), weight fraction of structural units are 1 to 30% by weight for q1 as described above, 5 to 80% by weight for p1, and 5 to 80% by weight for p2, and more preferably 15 to 60% by weight for p1, 15 to 60% by weight for p2, and 2 to 25% by weight for q1.

Specific examples of the divalent group of L² without the ion-exchange group include the followings:

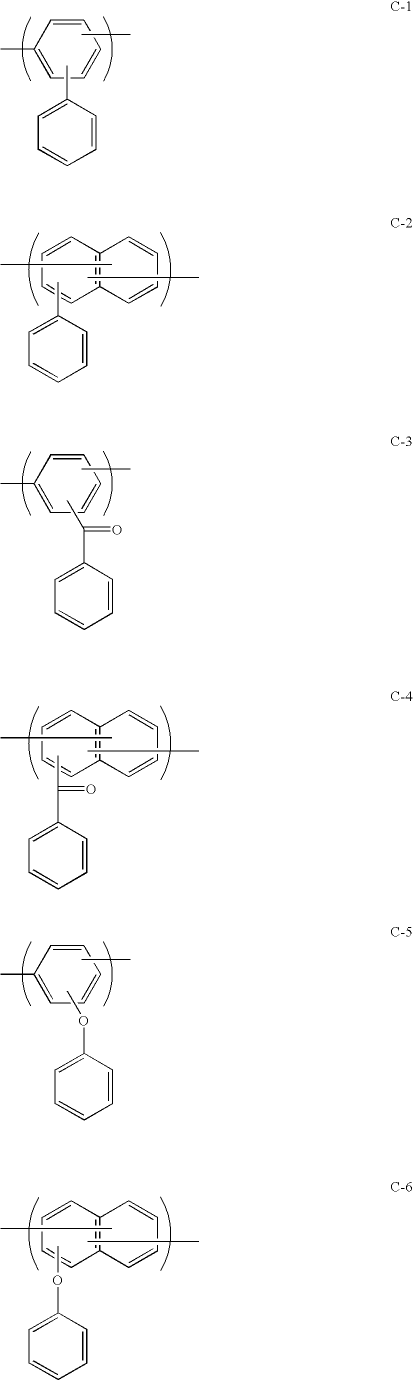

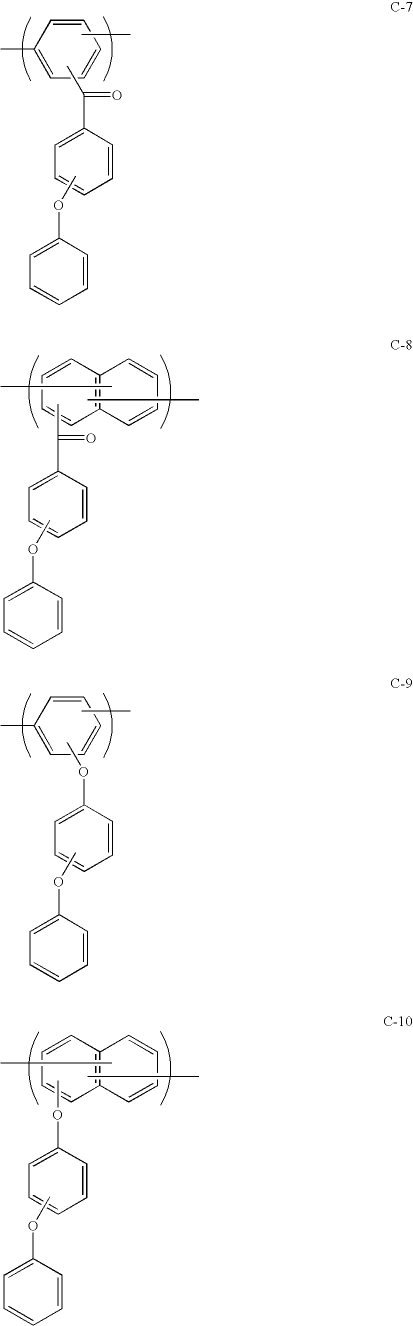

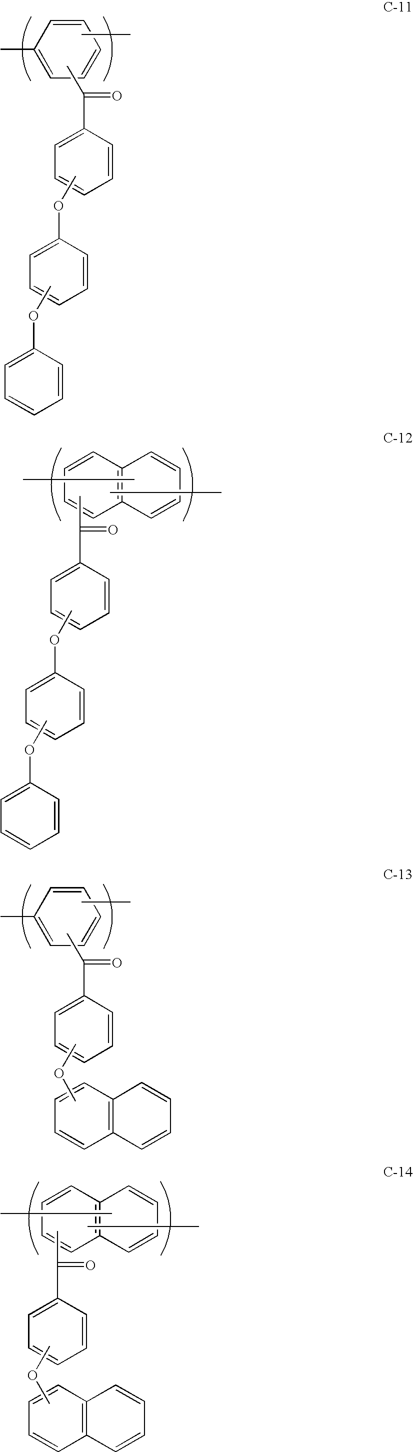

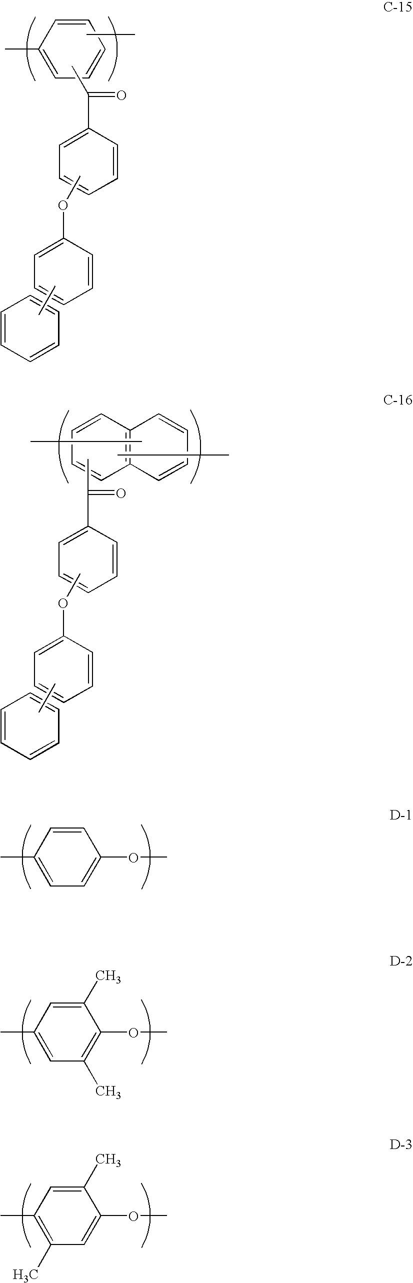

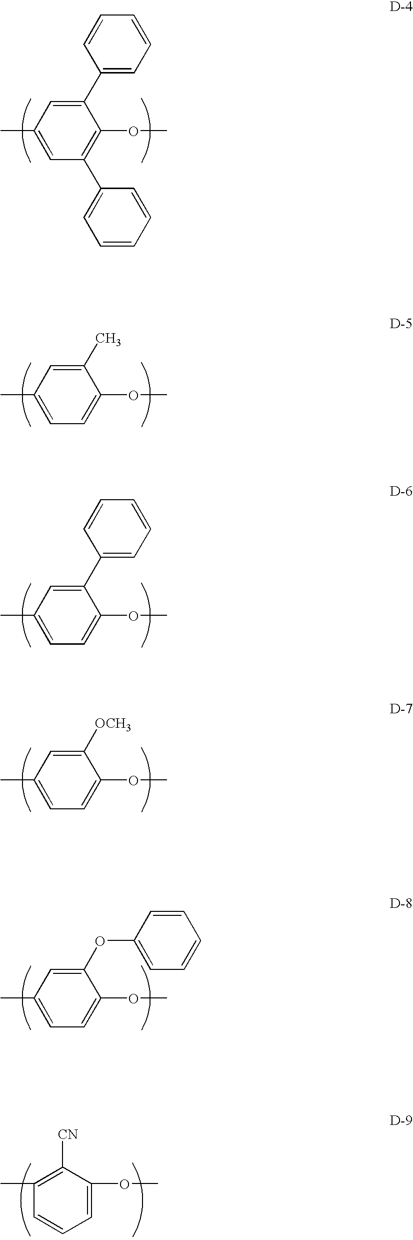

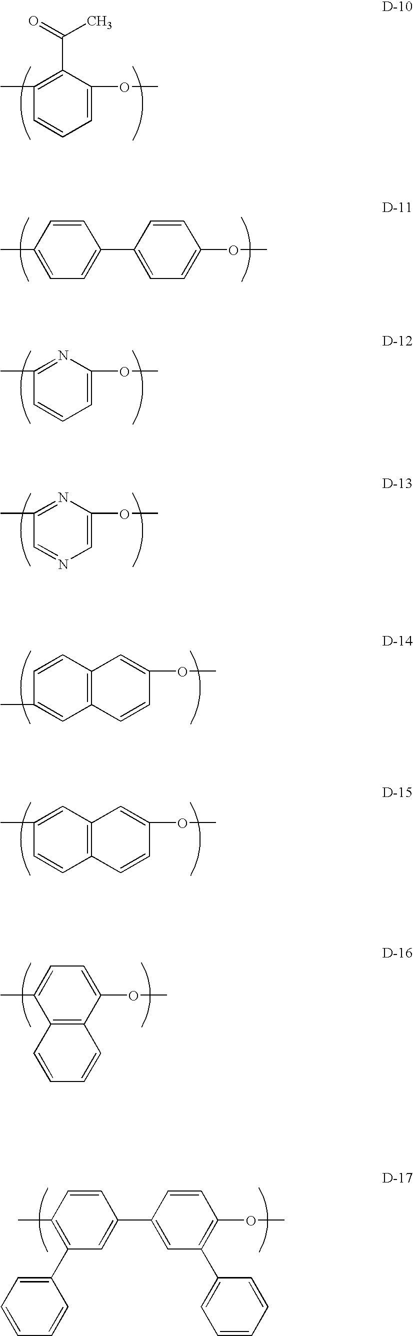

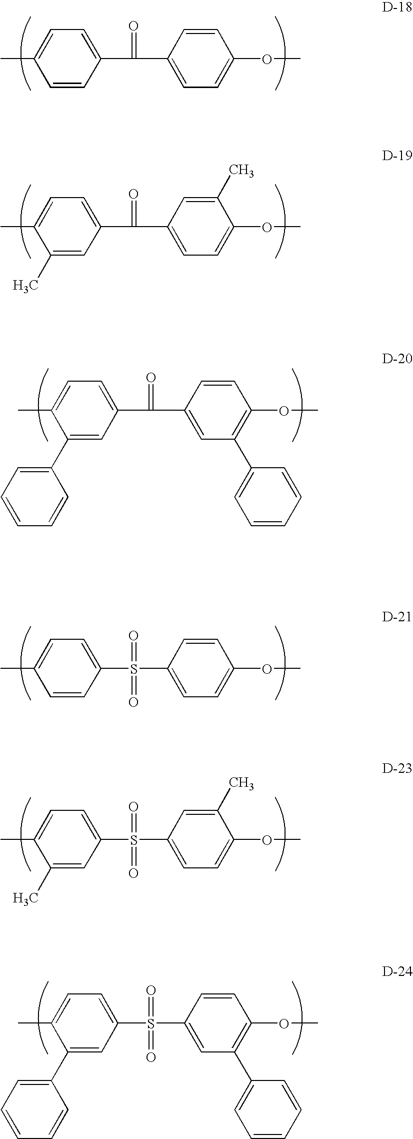

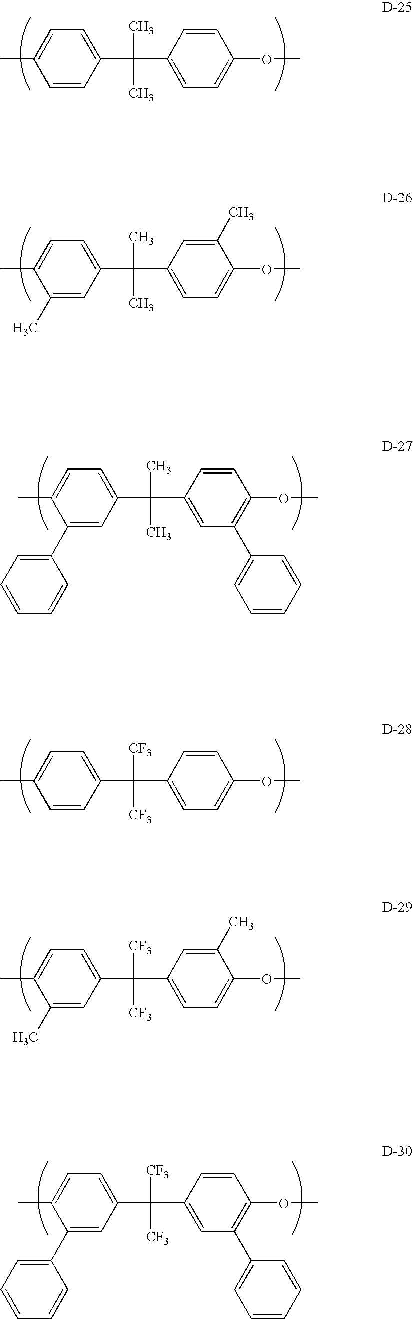

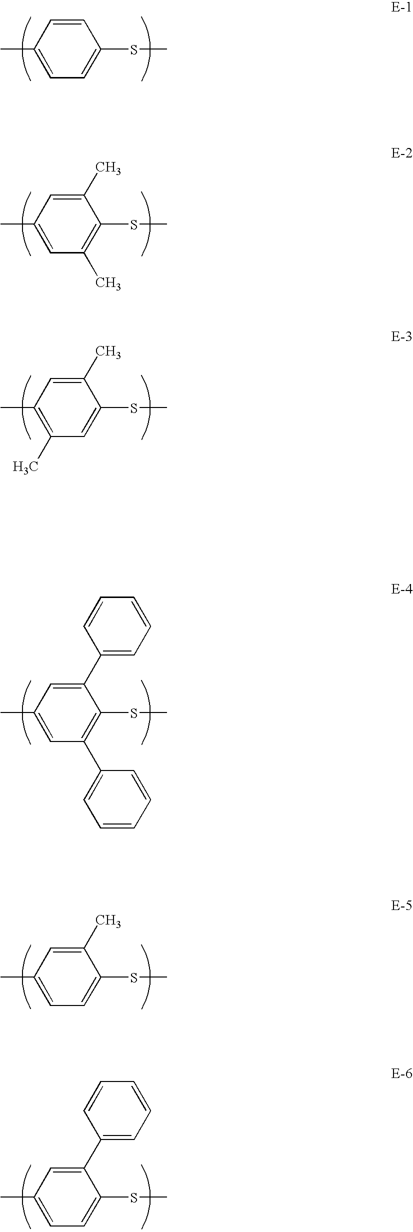

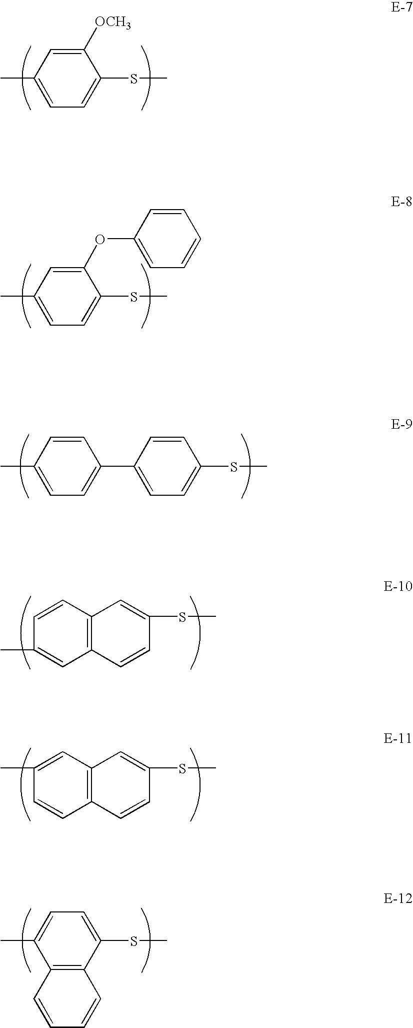

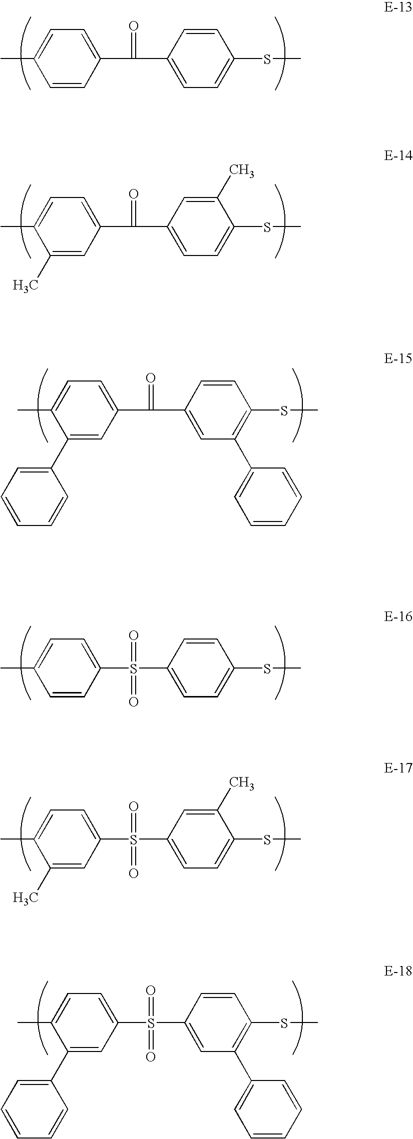

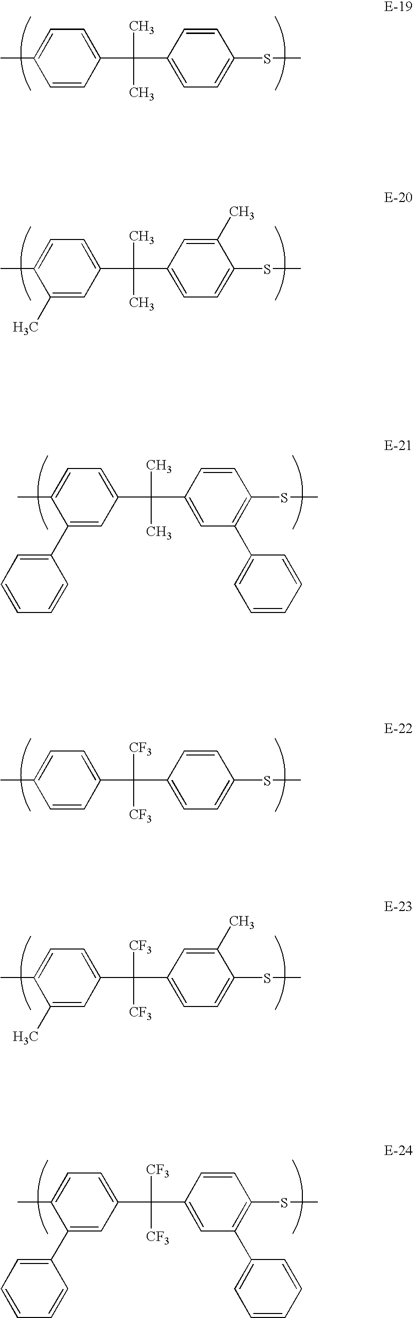

Specific examples of L¹ being the structural unit containing the ion-exchange group include those obtained by introducing at least one group selected from the group consisting of ion-exchange groups and groups containing an ion-exchange group shown below to an aromatic ring, in the specific examples of L².

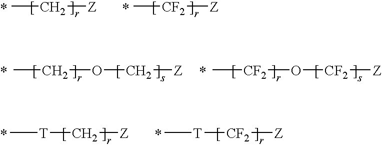

(in the formulae, Z is an ion-exchange group; r and s each independently represent an integer number from 0 to 12; T represents —O—, —S—, —CO—, or —SO₂—; and * represents a bond).

An amount of the ion-exchange group in the polymer electrolyte of the present invention is preferably 0.5 meq/g to 4.0 meq/g, and more preferably 0.8 meq/g to 3.5 meq/g represented by ion exchange capacity.

The polymer electrolyte having an ion exchange capacity of not less than 0.5 meq/g has high ion-conductivity and is suitable for components such as an ion-conductive membrane in a solid polymer fuel cell. The polymer electrolyte having an ion exchange capacity of not more than 4.0 meq/g preferably has better water resistance.

The polymer electrolyte of the present invention preferably has a molecular weight of 5000 to 1000000, and more preferably 15000 to 400000, represented by a number average molecular weight based on polystyrene standard.

Next, a method for producing the polymer electrolyte represented by the general formula (4) or the general formula (5), which is preferred among the polymer electrolytes of the present invention, will be described.

### [Method for Producing a Random Copolymer]

When the preferred polymer electrolyte of the present invention is a random copolymer of the structural unit having an ion-exchange group and the structural unit represented by the general formula (1), it can be prepared by copolymerizing monomers deriving the structural unit represented by the general formula (1) and monomers deriving the structural unit having the ion-exchange group.

In preparation of the polymer electrolyte by copolymerizing one or more monomers deriving the structural unit represented by the general formula (1) and one or more monomers deriving the other structural unit, examples of the monomer deriving the repeating structural unit represented by the general formula (1) include a monomer represented by the following general formula (20).

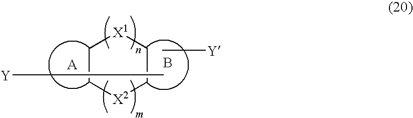

(in the formula, A-ring, B-ring, X¹, X², n and m are the same as those being defined in the general formula (1); Y and Y′ each independently represent a leaving group or a nucleophilic group).

The leaving group is a group selected from the group consisting of halogeno groups and —OSO₂G (wherein, G represent an alkyl group, a fluorine-substituted alkyl group or an aryl group). Examples of the nucleophilic group include a hydroxy and a mercapto groups.

Examples of the monomer deriving the structural unit having the ion-exchange group include a monomer represented by the general formula (21).

Q-L^{1a}-Q′ (21)

(in the formula, L^{1a} represents a divalent aromatic group having the ion-exchange group; Q and Q′ each independently represent a leaving group or a nucleophilic group).

Examples of a step for polymerization include: when the monomer represented by the general formula (20) has two leaving groups as Y and Y′ and the monomer represented by the general formula (21) has two leaving groups as Q and Q′, coupling them in the presence of a zero-valent transition metal catalyst to form a single bond among aromatic rings; and when the monomer represented by the general formula (20) has two leaving groups as Y and Y′ and the monomer represented by the general formula (21) has two nucleophilic groups as Q and Q′, copolymerizing them through condensation of a leaving group and a nucleophilic group to form an ether or a thioether bond. In copolymerization by condensation, a combination of monomers may be the monomer represented by the general formula (20) having two nucleophilic groups as Y and Y′ and the monomer represented by the general formula (21) having two leaving groups as Q and Q′, or a combination of monomers may be the monomer represented by the general formula (20) having a leaving group as Y and a nucleophilic group as Y′, and the monomer represented by the general formula (21) having a leaving group as Q and a nucleophilic group as Q′.

First, the step of coupling in the presence of a zero-valent transition metal catalyst is described.

Examples of the zero-valent transition metal complex include zero-valent nickel and zero-valent palladium complexes. Among them, zero-valent nickel complexes are preferably used.

The zero-valent transition metal complex may be a commercial product or previously prepared to be used in the polymerization system, or may be generated in the polymerization system from a transition metal compound due to a reductant. The latter case can be conducted by, for example, reacting the transition metal compound with the reductant.

In any case, the ligand described below is preferably added from the viewpoint of increased yield.

Examples of the zero-valent palladium complex include tetrakis(triphenylphosphine)palladium(0). Examples of the zero-valent nickel complex include bis(cyclooctadiene)nickel(0), (ethylene)bis(triphenylphosphine)nickel(0) and tetrakis(triphenylphosphine)nickel(0). Among them, bis(cyclooctadiene)nickel(0) is preferably used.

In the case of reacting the transition metal compound with the reductant to generate a zero-valent transition metal complex, the transition metal compound used is generally a divalent transition metal compound. It may also be a zero-valent transition metal compound. Among them, divalent nickel and divalent palladium compounds are preferred. Examples of the divalent nickel compound include nickel chloride, nickel bromide, nickel iodide, nickel acetate, nickel acetylacetonate, bis(triphenylphosphine) nickel chloride, bis(triphenylphosphine)nickel bromide and bis(triphenylphosphine)nickel iodide. Examples of the divalent palladium compound include palladium chloride, palladium bromide, palladium iodide and palladium acetate.

Examples of the reductant include metals such as zinc and magnesium, alloys such as these metals with copper, sodium hydride, hydrazine and derivatives thereof, and lithium aluminum hydride. Those can be used together with ammonium iodide, trimethylammonium iodide, triethylammonium iodide, lithium iodide, sodium iodide and potassium iodide, if necessary.

An amount of zero-valent transition metal complex used is, when the reductant is not used, generally 0.1 to 5.0 molar times to the total mole amount of the monomer represented by the general formula (20) and the monomer represented by the general formula (21). The too small usage tends to result in a product of lower molecular weight, and thus the amount is preferably not less than 1.5 molar times, more preferably not less than 1.8 molar times, and even more preferably not less than 2.1 molar times. The upper limit of the amount is desirably not more than 5.0 molar times, since the too large usage tends to require a complicated after-processing.

When the reductant is used, an amount of transition metal compound used is 0.01 to 1 molar times to the total mole amount of the monomer represented by the general formula (20) and the monomer represented by the general formula (21). The too small usage tends to result in a polymer electrolyte of lower molecular weight, and thus the amount is preferably not less than 0.03 molar times. The upper limit of the amount is desirably not more than 1.0 molar time, since the too large usage tends to require a complicated after-processing.

An amount of reductant used is generally 0.5 to 10 molar times to the total mole amount of the monomer represented by the general formula (20) and the monomer represented by the general formula (21). The too small usage tends to result in a polymer electrolyte of lower molecular weight, and thus the amount is preferably not less than 1.0 molar time. The upper limit of the amount is desirably not more than 10 molar times, since the too large usage tends to require a complicated after-processing.

Examples of the ligand include 2,2′-bipyridyl, 1,10-phenanthroline, methylene bis-oxazoline, N,N,N′,N′-tetramethylethylenediamine, triphenylphosphine, tritolylphosphine, tributylphosphine, triphenoxyphosphine, 1,2-bisdiphenylphosphinoethane and 1,3-bisdiphenylphosphinopropane. From the points of versatility, low cost, high reactivity and high yield, triphenylphosphine and 2,2′-bipyridyl are preferred. Since a combination with bis(1,5-cyclooctadiene)nickel(0) increases a yield of polymer, 2,2′-bipyridyl is particularly preferably used.

When the ligand coexists, an amount of the ligand used is generally about 0.2 to about 10 molar times, and preferably about 1.0 to about 5.0 molar times to the zero-valent transition metal complex based on the metal atom.

The coupling reaction is generally conducted in the presence of a solvent. Examples of the solvent include aromatic hydrocarbon solvents such as benzene, toluene, xylene, n-butylbenzene, mesitylene and naphthalene; ether solvents such as diisopropyl ether, tetrahydrofuran, 1,4-dioxane, diphenyl ether, dibutyl ether, tert-butylmethyl ether and dimethoxyethane; aprotic polar solvents such as N,N-dimethylformamide (hereinafter referred to as “DMF”), N,N-dimethylacetamide (hereinafter referred to as “DMAc”), N-methyl-2-pyrrolidone (hereinafter referred to as “NMP”), hexamethylphosphoric triamide and dimethylsulfoxide (hereinafter referred to as “DMSO”); aliphatic hydrocarbon solvents such as tetralin and decalin; ester solvents such as ethyl acetate, butyl acetate and methyl benzoate; and alkyl halide solvents such as chloroform and dichloroethane.

To increase a molecular weight of a produced polymer electrolyte, the solvent preferably sufficiently solves the produced polymer electrolyte, and thus tetrahydrofuran, 1,4-dioxane, DMF, DMAc, DMSO, NMP and toluene, which are good solvent to the polymer electrolyte, are preferred. They may be used in combination of two or more of them. Among solvents, DMF, DMAc, DMSO, NMP and mixed solvent of two or more of them are preferably used. As used herein, the “good solvent” means a solvent that can solve 5 g or more polymer electrolyte in 100 g of the solvent at 25° C.

The solvent is generally used in a range of 5 to 500 weight times, and preferably 20 to 100 weight times to the total weight of the monomer represented by the general formula (20) and the monomer represented by the general formula (21).

A reaction temperature is generally within the range from 0° C. to 250° C., and preferably about 10° C. to about 100° C. A condensation period is generally about 0.5 to about 24 hours. To increase a molecular weight of produced polymer, it is particularly preferred to react the zero-valent transition metal complex, the monomer represented by the general formula (20) and the monomer represented by the general formula (21) at a temperature not lower than 45° C. A preferred reaction temperature is generally 45° C. to 200° C., and preferably about 50° C. to about 100° C.

The method of reacting the zero-valent transition metal complex, the monomer represented by the general formula (20) and the monomer represented by the general formula (21) may be an operation of adding one to the other, or an operation of adding them simultaneously to a reactor. They may be added all at once, but preferably portionwise in terms of exothermic heat. Addition under the coexistence of a solvent is also preferred. A mixture thus obtained is hold at a temperature generally about 45° C. to about 200° C., and preferably about 50° C. to about 100° C.

Next, the step of copolymerization through condensation of a leaving group with a nucleophilic group is described.

The condensation reaction is a condensation reaction occurring between a leaving group and a nucleophilic group as described above. It is generally a nucleophilic substitution progressing in the presence of a basic catalyst.

Examples of the basic catalyst include sodium hydroxide, potassium hydroxide, cesium hydroxide, sodium carbonate, potassium carbonate, cesium carbonate, sodium hydrogen carbonate and potassium hydrogen carbonate. The basic catalyst is not specifically limited as long as it can convert a hydroxy group and a mercapto group, which are nucleophilic groups, into an alcoholate group and a thiolate group, respectively.

The condensation is generally conducted in the presence of a solvent. Examples of the solvent include aromatic hydrocarbon solvents such as benzene, toluene, xylene, n-butylbenzene, mesitylene and naphthalene; ether solvents such as diisopropyl ether, tetrahydrofuran, 1,4-dioxane, diphenyl ether, dibutyl ether, tert-butylmethyl ether and dimethoxyethane; aprotic polar solvents such as DMF, DMAc, NMP, hexamethylphosphoric triamide and DMSO; aliphatic hydrocarbon solvents such as tetralin and decalin; ester solvents such as ethyl acetate, butyl acetate and methyl benzoate; and alkyl halide solvents such as chloroform and dichloroethane.

To increase a molecular weight of a produced polymer, the solvent preferably sufficiently solves the produced polymer, and thus tetrahydrofuran, 1,4-dioxane, DMF, DMAc, DMSO, NMP and toluene, which are good solvents to the polymer, are preferred. They may be used in combination of two or more of them. Among solvents, DMF, DMAc, DMSO, NMP and mixed solvents of two or more of them are preferably used.

In some cases, water generates as a byproduct during the condensation reaction. If water generates, the water can be cut off from the reaction system as an azeotropic mixture by adding toluene and the like added to the reaction system.

The solvent is generally used in a range of 5 to 500 weight times, and preferably 20 to 100 weight times to the total weight of the monomer represented by the general formula (20) and the monomer represented by the general formula (21).

A condensation temperature is generally within the range from 0° C. to 350° C., and preferably about 50° C. to about 250° C. At a temperature lower than 0° C., the reaction is difficult to sufficiently progress, and at higher than 350° C., a product may be decomposed.

The methods of coupling in the presence of the zero-valent transition metal catalyst and of copolymerization through condensation are also applicable to production of the polymer electrolyte represented by the general formula (5). In this case, the production is easily achieved by replacing a part of the monomer represented by the general formula (21) with the monomer represented by the following general formula (22).

Q-L^{2a}-Q′ (22)

(in the formula, L^{2a} represents a divalent aromatic group without the ion-exchange group; Q and Q′ are the same as those being defined in the general formula (21)).

### [Production of Block Copolymer]

Next, a method for producing a block copolymer is described. A step of polymerization is preferably, similarly as in the random polymerization, coupling in the presence of a zero-valent transition metal catalyst, or copolymerization through condensation. The block copolymer can be obtained by: a) preparing respective polymers from the monomer represented by the general formula (20) and the monomer represented by the general formula (21), and coupling these polymers; or b) preparing a polymer from one of the monomers represented by the general formula (20) and the monomer represented by the general formula (21) and reacting the polymer with a monomer deriving the other polymer.

The methods (a) and (b) for producing a block copolymer are described with an example.

In the method (a), the monomer of the general formula (20) having two leaving groups as Y and Y′ is condensed in the presence of a zero-valent transition metal catalyst to produce a polymer represented by the following general formula (30).

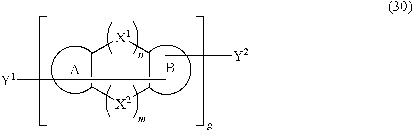

(in the formula, A-ring, B-ring, X¹, X², n and m are the same as those being defined in the general formula (1); Y¹ and Y² each represent a leaving group; and g represents an integer number not less than 2).

Beside that, the monomer of the general formula (21) having two leaving groups as Q and Q′ is condensed in the presence of a zero-valent transition metal catalyst to produce a polymer represented by the following general formula (31).

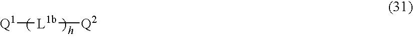

(in the formula, L^{1b} represents a divalent aromatic group having the ion-exchange group; Q¹ and Q² each independently represent a leaving group; and h represents an integer number not less than 2).

The polymer represented by the general formula (30) and the polymer represented by the general formula (31) thus obtained each have leaving groups at both ends, and are further coupled in the presence of a zero-valent transition metal catalyst to produce a block copolymer. Alternatively, the block copolymer can be obtained by condensing the polymers with a linking agent having nucleophilic groups in a molecule that binds to a leaving group by a nucleophilic reaction in the presence of a basic catalyst.

Examples of the linking agent having nucleophilic groups in a molecule include 4,4′-dihydroxybiphenyl, bisphenol A, 4,4′-dihydroxybenzophenone and 4,4′-dihydroxy diphenyl sulfone.

The block copolymer also can be obtained by a method of coupling the polymer represented by the general formula (31) with the monomer of the general formula (20) having two leaving groups as Y and Y′ in the presence of a zero-valent transition metal catalyst. Those obtained by condensing the polymer represented by the general formula (31) with the monomer of the general formula (20) having two nucleophilic groups as Y and Y′ are also included within the block copolymers of the present invention.

When the monomer represented by the general formula (20) in which Y is a leaving group and Y′ is a nucleophilic group is condensed, a polymer represented by the following general formula (40) can be obtained.

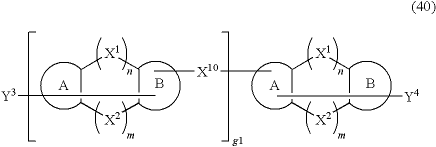

(in the formula, A-ring, B-ring, X¹, X², n and m are the same as those being defined in the general formula (1); Y³ represents a leaving group; Y⁴ represents a nucleophilic group; g1 represents an integer number not less than 1; and X¹⁰ represents an oxygen atom or a sulfur atom).

Further, when the monomer represented by the general formula (21) in which Q is a leaving group and Q′ is a nucleophilic group is condensed, a polymer represented by the following general formula (41) can be obtained.

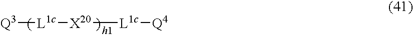

(in the formula, L^{1c} represents a divalent aromatic group having an ion-exchange group; X²⁰ represents an oxygen atom or a sulfur atom; Q³ represents a leaving group; and Q⁴ represents a nucleophilic group).

The block copolymer of the present invention can be also obtained by further condensing the polymer represented by the general formula (40) and the polymer represented by the general formula (41) thus obtained.

Those obtained by condensing the polymer represented by the general formula (41) with the monomer of the general formula (20) in which Y is a leaving group and Y′ is a nucleophilic group are also included within the block copolymers of the present invention.

When the monomer represented by the general formula (20) having two leaving groups as Y and Y′ and the monomer having two nucleophilic groups as Y and Y′ are condensed, a polymer represented by the following general formula (50) can be obtained.

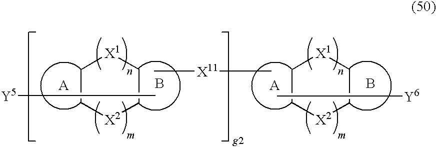

(in the formula, A-ring, B-ring, X¹, X², n and m are the same as those being defined in the general formula (1); Y⁵ and Y⁶ each represent a leaving group or a nucleophilic group; g2 represents an integer number not less than 1; and X¹¹ represents an oxygen atom or a sulfur atom).

Y⁵ and Y⁶ can be controlled according to a charging ratio of monomers. Excess use of the monomer having two leaving groups as Y and Y′ results in a polymer represented by the general formula (50) having two leaving groups as Y⁵ and Y⁶. In contrast, excess use of the monomer having two leaving groups as Y and Y′ results in a polymer represented by the general formula (41) having two leaving groups as Y⁵ and Y⁶.

When the monomer represented by the general formula (21) having two leaving groups as Q and Q′ and the monomer having two nucleophilic groups as Q and Q′ are condensed, a polymer represented by the following general formula (51) can be obtained.

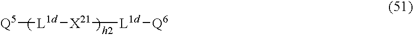

(in the formula, L^{1d} represents a divalent aromatic group having an ion-exchange group; X²¹ represents an oxygen atom or a sulfur atom; Q⁵ and Q⁶ each represent a leaving group or a nucleophilic group).

In the general formula (51), Q⁵ and Q⁶ can be similarly controlled as in the method for the polymer represented by the general formula (50).

The block copolymer of the present invention can be also obtained by further condensing the polymer represented by the general formula (50) and the polymer represented by the general formula (51) thus obtained. In this case, examples of a combination of Y⁵, Y⁶, Q⁵ and Q⁶ include a combination of the polymer represented by the general formula (50) having two leaving groups as Y⁵ and Y⁶ and the polymer represented by the general formula (51) having two nucleophilic groups as Q⁵ and Q⁶ as well as a combination of the polymer represented by the general formula (50) having two nucleophilic groups as Y⁵ and Y⁶ and the polymer represented by the general formula (51) having two leaving groups as Q⁵ and Q⁶.

The methods for producing the block copolymer are also applicable to production of the copolymer represented by the general formula (5) of the structural unit having an ion-exchange group, the structural unit without ion-exchange group and the structural unit represented by the general formula (1). In this case, the production is performed similarly to the method for producing the block copolymer, by replacing a part of the monomer represented by the general formula (20) with the monomer represented by the general formula (22), or by replacing a part of the monomer represented by the general formula (21) with the monomer represented by the general formula (22).

### [Purification Method of Polymer Electrolyte]

The random polymer and the block copolymer thus obtained can be collected from the reaction mixture by standard methods. For example, the produced polymer electrolyte is precipitated by adding a poor solvent in which the polymer electrolyte is insoluble or hardly soluble and filtered. The product can further be purified by washing with water or repeating dissolution-reprecipitation with a good solvent and a poor solvent, if necessary. Purification can be also a combination of two or more means. As used herein, the “poor solvent” means a solvent that cannot dissolve not less than 1 g of polymer electrolyte in 100 g of solvent at 25° C.

### [Fuel Cell]

Next, use of the polymer electrolyte of the present invention as a separator for electrochemical devices such as a fuel cell is described.

In this case, the polymer electrolyte of the present invention is generally used in the form of membrane. A method for forming a membrane is not specifically limited. For example, a method of forming a membrane from a solution (a solution casting method) is preferably employed.

To be more specific, the polymer electrolyte of the present invention is formed into a membrane by dissolving it in an appropriate solvent, cast-coating a substrate such as a glass plate with the solution, and removing the solvent. The solvent used in the membrane forming can be any solvent as long as it can dissolve the polymer electrolyte used and can be removed after the membrane is formed. Preferred examples of the solvent include aprotic polar solvents such as DMF, DMAc, NMP and DMSO; chlorine solvents such as dichloromethane, chloroform, 1,2-dichloroethane, chlorobenzene and dichlorobenzene; alcohols such as methanol, ethanol and propanol; and alkylene glycol monoalkyl ethers such as ethylene glycol monomethyl ether, ethylene glycol monoethyl ether, propylene glycol monomethyl ether and propylene glycol monoethyl ether. These may be used alone or in combination of two or more of them, if necessary. Among them, DMSO, DMF, DMAc and NMP have high capacity of dissolving the polymer and are preferred.

A thickness of the membrane is not specifically limited, but preferably 10 to 300 μm. A membrane having not less than 10 μm thickness preferably has excellent practical strength. A membrane having not more than 300 μm thickness preferably has small membrane resistance, resulting in an electrochemical device having enhanced characteristics. The membrane thickness can be controlled with a concentration of a solution and a thickness of coating on a substrate.

In order to improve physical properties of the membrane, those generally used in polymers such as a plasticizer, a stabilizer and a releasing agent can be added to the polymer electrolyte of the present invention. It is also possible to form a composite alloy of the polymer electrolyte of the present invention with another polymer by, for example, mixing them in the same solvent and co-casting.

In addition, in applications for fuel cell, it is also known to add inorganic or organic particles as a water retention agent for ease of water control. These known methods can be employed as long as these are not contrary to the object of the present invention. It is also possible to cross-link by irradiation of electron beam/radiation to increase mechanical strength of membrane and the like.

In order to further improve strength, flexibility and durability of a polymer electrolyte membrane comprising the polymer electrolyte of the present invention as an active ingredient, it is also possible to impregnate a porous substrate with the polymer electrolyte of the present invention to combine them and form a polymer electrolyte composite membrane. A method for combining can be any known method.

The porous substrate is not specifically limited as long as it meets the purpose of use, including porous membrane, woven fabric, non-woven fabric and fibril. These may be used in any shape and of any material. Considering heat resistance and reinforcing effect in physical strength, examples of a preferred material for the porous substrate include aliphatic, aromatic, and fluorine-containing polymers.

In use of the polymer electrolyte composite membrane comprising the polymer electrolyte of the present invention as a separator for a polymer electrolyte type fuel cell, a membrane thickness of the porous substrate is preferably 1 to 100 μm, more preferably 3 to 30 μm, and even more preferably 5 to 20 μm. A pore size of the porous substrate is preferably 0.01 to 100 μm, and more preferably 0.02 to 10 μm. A porosity of the porous substrate is preferably 20 to 98%, and more preferably 40 to 95%.

A porous substrate having not less than 1 μm of membrane thickness exhibits better effects of reinforcing strength or providing flexibility and durability in the composite membrane and hardly causes gas leak (cross leak). A porous substrate having not more than 100 μm of membrane thickness has lower electrical resistance and provides a composite membrane serving better to a separator to a solid polymer fuel cell. A porous substrate having not less than 0.01 μm of pore size is easy filled with a polymer solid electrolyte. A porous substrate having not more than 100 μm of pore size has larger reinforcing effect on a polymer solid electrolyte. A porous substrate having not less than 20% porosity has smaller resistance as a solid electrolyte membrane. A porous substrate having not more than 98% porosity has higher strength by itself and provides better reinforcing effect, which is preferred.

Then, the fuel cell of the present invention is described.

The fuel cell according to the present invention can be prepared by joining a catalyst ingredient and a conductive material as a current collector on both sides of the polymer electrolyte membrane prepared with the polymer electrolyte or the polymer electrolyte composite membrane comprising the polymer electrolyte as an active ingredient.

The catalyst ingredient is not specifically limited as long as it can activate a redox reaction with hydrogen or oxygen. Any known catalyst ingredient can be used. Preferably used are particles of platinum and platinum-based alloy. The particles of platinum and platinum-based alloy are often supported on particulate or fibrous carbon such as activated carbon, graphite and the like in use.

Alternatively, platinum-supported carbon is mixed together with an alcohol solution of a perfluoroalkylsulfonic acid resin as a polymer electrolyte to give a paste which is applied on a gas diffusion layer and/or polymer electrolyte membrane and/or polymer electrolyte composite membrane and dried to obtain a catalyst layer. Specific examples of the method that can be used include known methods, for example, a method described in J. Electrochem. Soc.: Electrochemical Science and Technology, 1988, 135 (9), 2209.

In the method, the polymer electrolyte of the present invention can be used instead of the perfluoroalkylsulfonic acid resin as a polymer electrolyte in the catalyst layer to prepare a catalyst composition.

The conductive material as a current collector also can be of any known material. Preferred are porous carbon woven fabric, carbon non-woven fabric and carbon paper, which effectively deliver a raw material gas to a catalyst.

The fuel cell according to the present invention thus prepared can be used in various types of use of a hydrogen gas, a modified hydrogen gas and methanol as a fuel.

The embodiments of the present invention are described above. These are intended to only illustrate examples, and not to limit the scope of the present invention. The scope of the present invention is defined by the claims, and encompasses meanings equivalent to and modification within the claims.

The present invention will be described with reference to the following Examples, but not limited to them at all.

### [Measurement]

### (1) Measurement of Molecular Weight

Molecular weights in Examples were number average molecular weights (Mn) and weight average molecular weights (Mw), based on the polystyrene standard and measured under the following conditions by gel permeation chromatography (GPC).

### Conditions

GPC measurement apparatus: HLC-8220 TOSOH corporation
Column: Shodex KD-80M+KD-803 by SHOWA DENKO K.K., which were connected
Column temperature: 40° C.
Mobile phase solvent: DMAc (LiBr was added so as to give 10 mmol/dm³)
Solvent flow rate: 0.5 mL/min

### (2) Measurement of Ion Exchange Capacity (IEC)

A polymer electrolyte was dissolved in dimethylsulfoxide (DMSO) to prepare a polymer electrolyte solution. The solution was spread on a glass plate and dried at 80° C. under normal pressure to give a polymer electrolyte membrane. The membrane was treated with 2N HCl for two hours and washed with ion-exchanged water to give a membrane in which an ion-exchange group was converted to a free acid type (proton type). Then, the membrane was dried in a halogen moisture content meter at 105° C. to determine a bone-dry weight. The membrane was immersed in 5 mL of 0.1 mol/L sodium hydroxide aqueous solution. To this was added 50 mL of ion-exchanged water and allowed to stand for two hours. To the solution in which the polymer electrolyte membrane was immersed was added 0.1 mol/L HCl dropwise for titration to determine a neutral point. The bone-dry weight and an amount of 0.1 mol/L HCl required for neutralization were used to determine an ion exchange capacity.

### (3) Measurement of Water Absorption Rate

The dried membrane was weighed, and immersed in deionized water for two hours at 80° C. A difference of weights of the membrane between before and after immersion was used to calculate a water absorption amount and a ratio to the weight of the dried membrane.

### (4) Measurement of Proton Conductivity

The polymer electrolyte membrane was cut into a strip of 1.0 cm width as a sample. Platinum plates (width: 5.0 mm) were pressed on the surface of the sample at 1.0 cm intervals. The sample was hold in a constant temperature and constant humidity chamber at 80° C. and 90% relative humidity, and measured for alternating-current impedance between platinum plates at 10⁶ to 10⁻¹ Hz. The measured value was assigned to the following calculation general formula to calculate proton conductivity (σ) (S/cm) of the polymer electrolyte membrane.

σ(S/cm)=1/(R×d)

[in the general formula, R(Ω) is the real part of the complex impedance when the imaginary part of the complex impedance is 0, on a call-call plot; and d (cm) is a membrane thickness of the strip.]

### Example 1

Under argon atmosphere, 95 ml of DMSO, 4.00 g (13.02 mmol) of sodium 3-(2,5-dichlorophenoxy)propanesulfonate, 2.94 g (11.72 mmol) of 2,5-dichlorobenzophenone, 0.44 g (1.30 mmol) of 2,7-dibromofluorenone and 11.19 g (71.63 mmol) of 2,2′-bipyridyl were charged into a flask, stirred and raised to 70° C. Then, to this was added 17.91 g (65.12 mmol) of bis(cyclooctadiene)nickel(0), raised to 80° C., and stirred for 5.5 hours at the same temperature. The mixture was allowed to cool, and poured into a large amount of 4N HCl to precipitate polymers. The polymers were filtered, washed with water until the filtrate water became neutral, washed with acetone, and dried under reduced pressure to give 5.04 g (yield: 98%) of desired polymer (polymer electrolyte). Considering that there was almost no remaining monomer detected after reaction, and that a collected amount of the resultant polymer is approximately equal to the theoretical amount, weight fraction of 2,7-fluorenonediyl group (a structural unit represented by the general formula (1)) in the polymer is estimated at 4.5% by weight from the amount of monomer charged.

Mn=99000, Mw=408000,

IEC=2.48 meq/g

(IEC calculated with the amount of monomer charged: 2.52 meq/g)

Proton conductivity: 1.7×10⁻¹ S/cm

Water absorption rate: 159%

### Comparative Example 1

Under argon atmosphere, 95 ml of DMSO, 4.00 g (13.02 mmol) of sodium 3-(2,5-dichlorophenoxy)propanesulfonate, 3.27 g (13.02 mmol) of 2,5-dichlorobenzophenone and 12.31 g (78.79 mmol) of 2,2′-bipyridyl were charged into a flask, stirred and raised to 60° C. Then, to this was added 19.70 g (71.63 mmol) of bis(cyclooctadiene)nickel(0), raised to 80° C., and stirred for 9 hours at the same temperature. The mixture was allowed to cool, and poured into a large amount of 4N HCl to precipitate polymers. The polymers were filtered, washed with water until the filtrate water became neutral, washed with acetone, and dried under reduced pressure to give 5.10 g of desired polymer (polymer electrolyte).

Mn=104000, Mw=270000,

IEC=2.40 meq/g

(IEC calculated with the amount of monomer charged: 2.54 meq/g)

Proton conductivity: 1.8×10⁻¹ S/cm

Water absorption rate: unmeasurable (the membrane was dissolved during immersion in deionized water at 80° C.)

### Example 2

Under argon atmosphere, 175 ml of DMSO, 100 ml of toluene, 8.00 g (26.05 mmol) of sodium 3-(2,5-dichlorophenoxy)propanesulfonate, 5.89 g (23.44 mmol) of 2,5-dichlorobenzophenone, 0.43 g (1.56 mmol) of 1,5-dichloroanthraquinone, 21.93 g (140.40 mmol) of 2,2′-bipyridyl were charged into a flask equipped with an azeotropic distillation device, heated and stirred at 145° C. to dehydrate by azeotropic distillation. Then, toluene was distilled off, and the reaction was cooled to 65° C. To this was added 35.11 g (127.63 mmol) of bis(cyclooctadiene)nickel(0), and stirred for 9 hours at the same temperature. The mixture was allowed to cool, and poured into a large amount of methanol to precipitate polymers. The polymers were repeatedly filtered and washed with 6 mol/L HCl in several times, washed with water until the filtrate water became neutral, and dried under reduced pressure to give 9.63 g (yield: 95%) of desired polymer (polymer electrolyte). Considering that there was almost no remaining monomer detected after the reaction, and that a collected amount of the resultant polymer is approximately equal to the theoretical amount, weight fraction of 1,5-anthraquinonediyl group (a structural unit represented by the general formula (1)) in the polymer is estimated at 3.2% by weight from the amount of monomer charged.

IEC=2.46 meq/g

(IEC calculated with the amount of monomer charged: 2.57 meq/g)

Proton conductivity: 1.3×10⁻¹ S/cm

Water absorption rate: 317%

### Example 3

A polymer (polymer electrolyte) was similarly prepared as in Example 2, except that 1,5-dichloroanthraquinone was 0.72 g (2.60 mmol), 2,2′-bipyridyl was 22.37 g (143.26 mmol), and bis(cyclooctadiene)nickel(0) was 35.82 g (130.24 mmol). Yield was 10.20 g (99%). Weight fraction of 1,5-anthraquinonediyl group (a structural unit represented by the general formula (1)) is estimated at 5.2% by weight from the amount of monomer charged.

As clearly shown from a comparison among Examples 1 and 2 and Comparative Example 1, introduction of the structural unit represented by the general formula (1) provides high proton conductivity and water resistance together to the polymer electrolyte of the present invention. That is, the polymer electrolyte of the present invention has output characteristics and durability together suitable for fuel cell and is particularly useful in applications including fuel cell.

1. A polymer electrolyte comprising a structural unit represented by the following general formula (1) in weight fraction of 1 to 30% by weight: 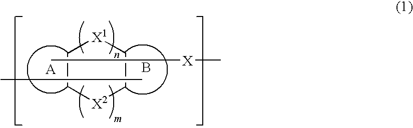
(in the formula, A-ring and B-ring each independently represent an optionally-substituted aromatic hydrocarbon ring or an optionally-substituted heterocyclic ring; X¹ and X² each independently represent —CO—, —SO— or —SO₂—; n and m each independently represent 0, 1 or 2, and n+m is not less than 1; when n is 2, two X¹s may be the same as or different from each other; when m is 2, two X²s may be the same as or different from each other; and X represents a direct bond or a divalent group).

2. The polymer electrolyte according to claim 1, wherein A-ring and B-ring each independently represent an aromatic hydrocarbon ring without the ion-exchange group as a substituent or a heterocyclic ring without the ion exchange group as a substituent, further comprising a structural unit having an ion-exchange group as an additional structural unit.

3. The polymer electrolyte according to claim 1 represented by the following general formula (5): 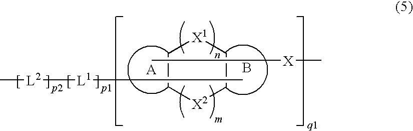
(in the formula, A-ring, B-ring, X¹, X², x, n and m are the same as those being defined in the general formula (1); p1, p2 and q1 represent weight fraction of respective structural units, and p1+p2+q1=100% by weight; L¹ represents a structural unit having an ion-exchange group; and L² represents a structural unit without the ion exchange group).

4. The polymer electrolyte according to claim 1, wherein X¹ represents —CO—, n=1, and m 0 in the general formula (1).

5. The polymer electrolyte according to claim 1, wherein X¹ and X² represent —CO—, n=1, and m=1 in the general formula (1).

6. The polymer electrolyte according to claim 1, wherein the structural unit represented by the general formula (1) is a structural unit represented by the general formula (2) and/or a structural unit represented by the general formula (3): 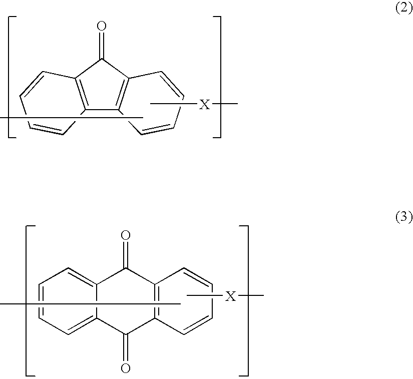
(in the formula, X is the same as that being defined in the general formula (1)).

7. The polymer electrolyte according to claim 1, wherein the structural unit represented by the general formula (1) is a structural unit represented by the general formula (2a) and/or a structural unit represented by the general formula (3a): 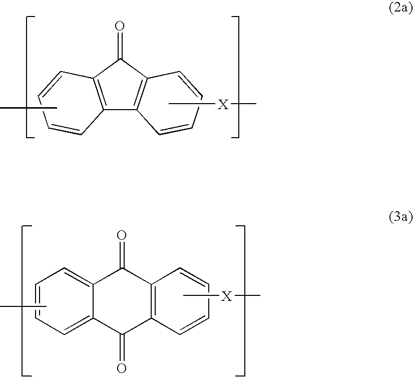
(in the formula, x is the same as that being defined in the general formula (1)).

8. A polymer electrolyte membrane comprising any one of polymer electrolytes according to claim 1.

9. A polymer electrolyte composite membrane comprising any one of polymer electrolytes according to claim 1 and a porous substrate.

10. A membrane-electrode assembly comprising the polymer electrolyte membrane according to claim 8 and a catalyst layer.

11. A catalyst composition comprising any one of polymer electrolytes according to claim 1 and a catalyst ingredient.

12. A membrane-electrode assembly including a catalyst layer comprising the catalyst composition according to claim 11.

13. A solid polymer fuel cell comprising at least one of the polymer electrolyte membrane according to claim 8.

14. A solid polymer fuel cell comprising the membrane-electrode assembly according to claim 10.
